(19) United States
(12) Patent Application Publication
(10) Pub. No.: US 2005/0240783 A1
(43) Pub. Date: Oct. 27, 2005

(54) Monitoring a voltage level of a power supply for a disk drive

(75) Inventor: Avraham Perahia, San Jose, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA (US)

(21) Appl. No.: 11/110,658

(22) Filed: Apr. 20, 2005

Related U.S. Application Data
(60) Provisional application No. 60/564,341, filed on Apr. 21, 2004.

(51) Int. Cl. G06F 1/26

(52) U.S. Cl. 713/300

(57) ABSTRACT

One embodiment of the present invention is a method for operating a disk drive including: (a) monitoring an operating voltage of a power source for the disk drive; and (b) preventing a write operating of the disk drive and continuing one or more other operations of the disk drive when the operating voltage is at or lower than a write-preventing threshold voltage.

This application claims the benefit of U.S. Provisional Application No. 60/564,341 which was filed on Apr. 21, 2004 and which is incorporated herein by reference.

### TECHNICAL FIELD OF THE INVENTION

One or more embodiments of the present invention relate to a method for operating a disk drive, and more particularly, a method for operating a disk drive that includes monitoring an operating voltage of a power supply for the disk drive.

### BACKGROUND OF THE INVENTION

A small form factor disk drive is typically used in a host device that is a battery-operated device, and as such, the disk drive operates on current supplied by a battery set that includes one or more batteries. In such an environment, as charge provided by the battery set in the form of current is consumed by the device and disk drive, an operating voltage of the battery set drops—typically, the operating voltage of the battery set drops slowly. Conventionally, the operating voltage is monitored by a protection circuit that is generally called a “watch dog” circuit. Such a watch dog circuit and can be implemented in the disk drive, in the battery-operated hose device, or partially in the disk drive and partially in the battery-operated hose device. When the operating voltage drops down to or below a threshold, the protection circuit will suspend operation of the disk drive and will perform a disk drive reset to reset the electronics and mechanical parts of the disk drive to a “safe mode.”

If the disk drive is reset while it is in the process of writing data to a disk, data will be corrupted at the disk location at which data is being written. Further, the disk drive reset prevents the disk drive from reporting data corruption to the battery-operated host device, and as a result, the data usually will be lost. In addition, a disk drive reset tends to be triggered by a write operation of the disk drive that is executed when the operating voltage is close to the threshold because the write operation typically causes a step increase in current consumption that may cause the operating voltage to drop to or below the threshold. As a result, data corruption and/or data loss often accompany disk drive resets in battery-operated host devices having such conventional protection circuits.

In light of the above, there is a need in the art for a method or apparatus that solves one or more of the above-identified problems.

### SUMMARY OF THE INVENTION

One or more embodiments of the present invention solve one or more of the above-identified problems. In particular, one embodiment of the present invention is a method for operating a disk drive comprising: (a) monitoring an operating voltage of a power source for the disk drive; and (b) preventing a write operation of the disk drive and continuing one or more other operations of the disk drive when the operating voltage is at or lower than a write-preventing threshold voltage.

### BRIEF DESCRIPTION OF THE DRAWING

FIG. 1 shows an electronic device that is fabricated in accordance with one or more embodiments of the present invention which includes a disk drive comprising an apparatus for monitoring an operating voltage level;

FIG. 2 is a flowchart of a method that is fabricated in accordance with one or more embodiments of the present invention (which, for example and without limitation, utilizes the apparatus shown in FIG. 1) for monitoring an operating voltage level;

FIG. 3 shows a hardware implementation of a voltage monitor used in the disk drive shown in FIG. 1, which voltage monitor is fabricated in accordance with one or more embodiments of the present invention;

FIG. 4 shows a software and firmware implementation of a voltage monitor used in the disk drive shown in FIG. 1, which voltage monitor is fabricated in accordance with one or more embodiments of the present invention; and

FIG. 5 shows a hardware, software and firmware implementation of a voltage monitor used in the disk drive shown in FIG. 1, which voltage monitor is fabricated in accordance with one or more embodiments of the present invention.

### DETAILED DESCRIPTION

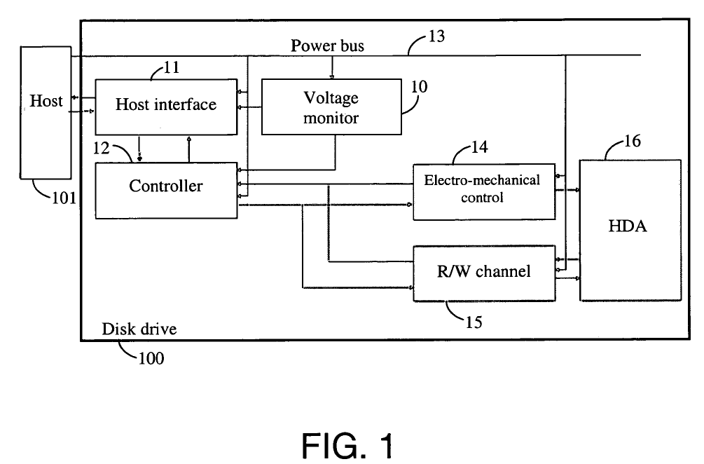

FIG. 1 shows an electronic device that is fabricated in accordance with one or more embodiments of the present invention which includes a disk drive comprising an apparatus for monitoring an operating voltage level. As shown in FIG. 1, the electronic device includes host 101 which communicates with disk drive 100 using host interface 11. In addition, disk drive 100 obtains power from a battery set (not shown) disposed in host 101 over power bus 13. As further shown in FIG. 1, power is supplied to host interface 11, controller 12, voltage monitor 10, electro-mechanical control 14, and read/write channel 15 (R/W channel 15) from power bus 13. The disk read/write operations performed by disk drive 100 are performed by head-disk assembly 16 (HDA 16, shown in FIG. 1).

As indicated in FIG. 1, HDA 16 receives commands related to read/write operations from R/W channel 15, and transfers/receives data to/from R/W channel 15 in a conventional manner. In addition, HDA 16 receives commands related to other electrical and mechanical operations of HDA 16 from electro-mechanical control 14 in a conventional manner. In addition, as further indicated in FIG. 1, commands and data are transferred between controller 12 and electro-mechanical control 14 and R/W channel 15 in a conventional manner. R/W channel 15 and electro-mechanical control 16 are conventional components.

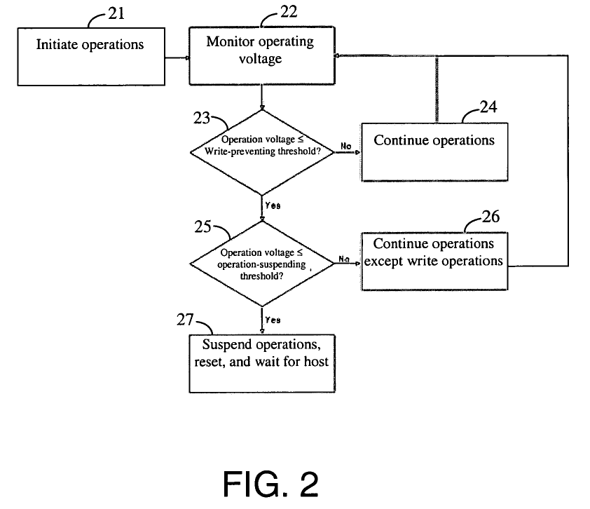

FIG. 2 is a flowchart of a method that is fabricated in accordance with one or more embodiments of the present invention (which, for example and without limitation, utilizes the apparatus shown in FIG. 1) for monitoring the operating voltage level. The method starts with step 21 (shown in FIG. 2) at which host 101 (shown in FIG. 1) initiates operations of disk drive 100 (shown in FIG. 1) in a conventional manner by sending a command through host interface 11 to controller 12 (shown in FIG. 1). Controller 12 responds by initiating commands in a conventional manner. Then, control is transferred to step 22 (shown in FIG. 2).

At step 22 (shown in FIG. 2), while disk drive 100 is performing conventional disk operations, voltage monitor 10 (shown in FIG. 1) performs the following tasks. It: (a) monitors an operating voltage provided by power bus 13 (shown in FIG. 1); (b) compares the operating voltage with a “write-preventing” threshold voltage, and generates a first comparison result; (c) compares the operating voltage with an “operation-suspending” threshold voltage, and generates a second comparison result; and (d) reports the first and second comparison results to controller 12. The operation-suspending threshold voltage is a voltage used to trigger a suspension of all operation of disk drive 100, and a reset of disk drive 100. Suitable values of operation-suspending threshold voltage are well known to those of ordinary skill in the art. In accordance with one or more embodiments of the present invention, the write-preventing threshold voltage is a voltage that is sufficiently higher than the operation-suspending threshold so that a decrease of the operating voltage caused by a write operation of disk drive 100 normally will not trigger a reset of disk drive 100 that tends to result in data corruption or loss during a write operation. Therefore, one ought to use a value of the write-preventing threshold voltage that is high enough to provide data protection. However, the write-preventing threshold voltage should also be low enough to avoid unnecessary interruption of write operations of disk drive 100. A suitable value of the write-preventing threshold voltage can be determined by one or ordinary skill in the art routinely and without undue experimentation using one or more processes that are well known to one or ordinary skill in the art including, for example and without limitation, mathematical modeling and optimization. Then, control is transferred to step 23 (shown in FIG. 2).

At step 23 (shown in FIG. 2), controller 12 determines whether to change the operation of disk drive 100 based on the first comparison result reported by voltage monitor 10. If the operating voltage is greater than the write-preventing threshold voltage, control is transferred to step 24 (shown in FIG. 2), and if the operating voltage is less than or equal to the write-preventing threshold voltage, control is transferred to step 25 (shown in FIG. 2).

At step 24 (shown in FIG. 2), disk drive 100 continues its operation. Then, control is transferred back to step 22 where voltage monitor 10 continues to perform its monitoring, comparing, and reporting tasks.

At step 25 (shown in FIG. 2), controller 12 determines whether to change operation of disk drive 100 based on the second comparison result reported by voltage monitor 10. If the operating voltage is greater than the operation-suspending threshold voltage, control is transferred to step 26 (shown in FIG. 2), and if the operating voltage is less than or equal to the operation-suspending threshold voltage, control is transferred to step 27 (shown in FIG. 2).

At step 26 (shown in FIG. 2), controller 12 commands R/W channel 15 to prevent any write operation in HDA 16 but allows disk drive 100 to continue with other operations. Then control is transferred back to step 22, at which voltage monitor 10 continues to perform its monitoring, comparing, and reporting tasks.

At step 27 (shown in FIG. 2), controller 12 commands disk drive 100 to suspend all operations and to reset all of its electrical and mechanical parts to a safe mode. All operations of disk drive 100, including operations of controller 12, are suspended until host 101 initiates operations of disk drive 100 again.

In accordance with one or more embodiments of the present invention, voltage monitor 10 in FIG. 1 may be fabricated using: (a) hardware; (b) software and firmware; or (c) hardware, software, and firmware. Further, in accordance with one or more embodiments, voltage monitor 10 may be readily customized and included in a driver chip by a supplier such as, for example and without limitation, STMicroelectronics, Inc. (www.st.com) of Carrollton, Tex. or Marvell Semiconductor, Inc. (www.marvell.com) of Sunnyvale, Calif.

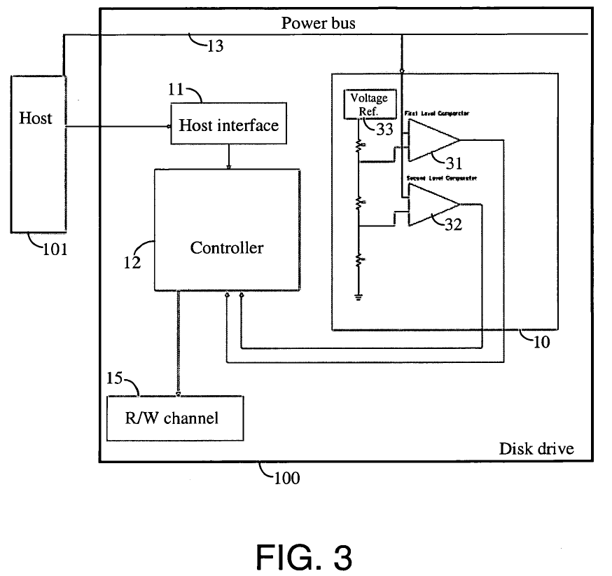

FIG. 3 shows a hardware implementation of voltage monitor 10 used in disk drive 100 shown in FIG. 1, which voltage monitor 10 is fabricated in accordance with one or more embodiments of the present invention. As shown in FIG. 3, in accordance with one or more embodiments of the present invention, voltage monitor 10 includes voltage reference 33, first comparator 31, and second comparator 32. Voltage reference 33 is adapted to apply a write-preventing threshold voltage as input to first comparator 31 and an operation-suspending threshold voltage as input to second comparator 32. In accordance with one or more such embodiments, the operating voltage is continuously monitored and continuously compared with the write-preventing threshold voltage and the operation suspending threshold voltage by first comparator 31 and second comparator 32, respectively. Nevertheless, for efficient use of controller 12, step 23 of the method shown in FIG. 2 may be performed only before write operations.

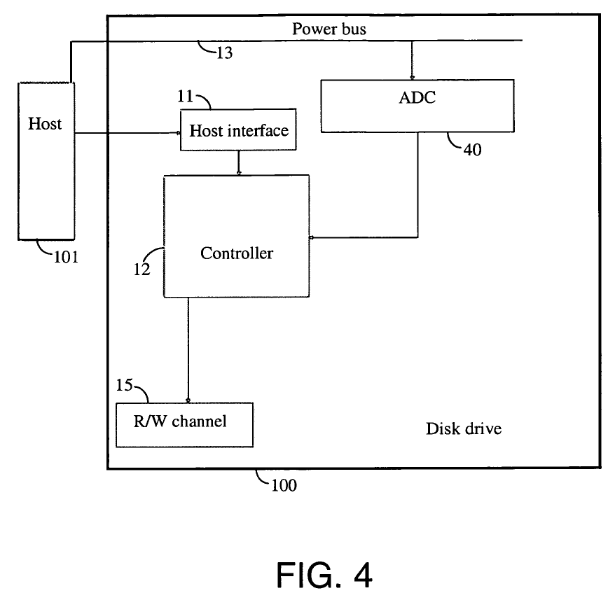

FIG. 4 shows a software and firmware implementation of voltage monitor 10 used in disk drive 100 shown in FIG. 1, which voltage monitor 10 is fabricated in accordance with one or more embodiments of the present invention. As shown in FIG. 4, in accordance with one or more embodiments of the present invention, analog-to-digital converter 40 (ADC 40) is used as voltage monitor 10. In accordance with one or more such embodiments, ADC 40 compares the operating voltage with the write-preventing threshold voltage or the operation-suspending threshold voltage upon receiving a particular request from controller 12, i.e., not continuously. Further, in accordance with one or more further embodiments of the present invention, the functionality provided by ADC 40 may be implemented using controller 12 or any other chip of disk drive 100. Still further, in accordance with one or more still further embodiments of the present invention, the functionality provided by ADC 40 may be implemented in host 101. In any of these embodiments, controller 12 firmware queries ADC 40 to provide the appropriate comparison result.

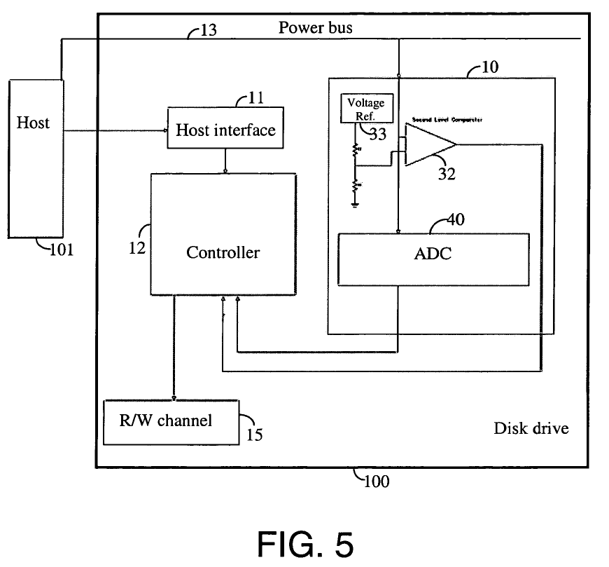

FIG. 5 shows a hardware, software and firmware implementation of voltage monitor 10 used in disk drive 100 shown in FIG. 1, which voltage monitor 10 is fabricated in accordance with one or more embodiments of the present invention and. As shown in FIG. 5, in accordance with one or more embodiments of the present invention, voltage monitor 10 includes voltage reference 33, comparator 32, and ADC 40. Voltage reference 33 is adapted to apply an operation-suspending threshold voltage as input to comparator 32. In accordance with one or more such embodiments, the operating voltage is continuously monitored and continuously compared with the operation suspending threshold voltage by comparator 32. ADC 40 compares the operating voltage with a write-preventing threshold upon receiving a request from controller 12, i.e., not continuously. Further, in accordance with one or more further embodiments of the present invention, the functionality provided by ADC 40 may be implemented using controller 12 or any other chip of disk drive 100. Still further, in accordance with one or more still further embodiments of the present invention, the functionality provided by ADC 40 may be implemented in host 101.

Advantageously in accordance with one or more embodiments of the present invention, a disk drive that operates with an apparatus and/or method fabricated in accordance with one or more embodiments of the present invention may avoid data corruption and loss under voltage fault conditions and therefore may have reliable write operations.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. A method for operating a disk drive comprising:
monitoring an operating voltage of a power source for the disk drive; and
preventing a write operation of the disk drive and continuing one or more other operations of the disk drive when the operating voltage is at or lower than a write-preventing threshold voltage.

2. The method of claim 1 further comprising suspending a plurality of operations of the disk drive when the operating voltage is at or lower than an operation-suspending threshold voltage.

3. The method of claim 2 wherein the operation-suspending threshold voltage is lower than the write-preventing threshold voltage.

4. The method of claim 1 wherein the power source comprises one or more batteries.

5. A disk drive comprising:
a voltage reference adapted to provide a write-preventing threshold voltage;
a comparator adapted to compare the write-preventing threshold voltage with an operating voltage of a power source for the disk drive; and
a controller adapted to prevent write operations of the disk drive and continue other operations of the disk drive when the operating voltage is at or lower than the write-preventing threshold voltage.

6. A disk drive comprising:
a voltage monitor adapted to: (a) monitor an operating voltage of a power source of the disk drive, (b) compare the operating voltage with a “write-preventing” threshold voltage, and generate a first comparison result, and (c) compare the operating voltage with an “operation-suspending” threshold voltage;
wherein the controller executes the following algorithm:
if the operating voltage is greater than the write-preventing threshold voltage, the disk drive continues its operation;
if the operating voltage is less than or equal to the write-preventing threshold voltage, and if the operating voltage is greater than the operation-suspending threshold voltage, write operations are prevented;
if the operating voltage is less than or equal to the write-preventing threshold voltage, and if the operating voltage is less than or equal to the operation-suspending threshold voltage, all disk operations of the disk drive are suspended.
